(19) United States
(12) Patent Application Publication
(10) Pub. No.: US 2005/0031927 A1
(43) Pub. Date: Feb. 10, 2005

(54) Polyelectrolyte membrane, method for its production and fuel cell using said polyelectrolyte membrane

(75) Inventors: Teresa Napolitano, Cimitile (IT); Salvatore Coffa, Tremestieri Etneo (IT); Giuseppe Mensitieri, Napoli (IT); Anna Borriello, Portici (IT); Luigi Nicolais, Ercolano (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (IT)

(21) Appl. No.: 10/879,696

(22) Filed: Jun. 29, 2004

(30) Foreign Application Priority Data
Jun. 30, 2003 (EP) 03425429.2

(51) Int. Cl. H01M 8/10; H01M 6/18; C08J 5/20; C25C 7/04; C25B 13/00

(52) U.S. Cl. 429/33; 429/309; 429/314; 521/27; 204/296

(57) ABSTRACT

A polyelectrolyte membrane includes at least one syndiotactic styrenic polymer or copolymer in its clathrate form. The syndiotactic styrenic polymer or copolymer in its clathrate form is syndiotactic polystyrene. The polyelectrolyte membrane has a good electrical conductivity as well as good mechanical properties. This type of membrane is used for fuel cells and similar electrochemical applications.

### FIELD OF THE INVENTION

The present invention relates to polyelectrolyte membranes for electrochemical applications, such as for fuel cells. More particularly, the present invention relates to a polyelectrolyte membrane that is produced by forming the polyelectrolyte into a film, as well as to a fuel cell using the polyelectrolyte membrane.

### BACKGROUND OF THE INVENTION

In recent years, attention has been paid to new energy techniques in view of environmental problems. One of these new energy techniques is a fuel cell. The fuel cell converts chemical energy to electrical energy by electrochemically reacting hydrogen with oxygen, and exhibits a high-energy efficiency.

Conventional fuel cells have been classified into phosphoric acid-type fuel cells, molten carbonate-type fuel cells, solid oxide-type fuel cells, solid polymer type fuel cells, etc., according to the kinds of electrolytes used. As a hydrogen source for the fuel cells, methanol, natural gases and the like have been used by being converted or reformed into hydrogen in the fuel cells. Among these fuel cells, the solid polymer-type fuel cells using a polyelectrolyte membrane (high-polymer ion-exchange membrane) as an electrolyte thereof, has a simple structure and is easy to maintain, and is therefore expected to be applied especially in the automotive field.

The main function of the membrane in the fuel cell is to transport protons from the anode where the protons are formed by decomposition of hydrogen gas, to the cathode where the protons react with oxygen gas and electrons to form water (FIG. 1). Furthermore, the membrane should provide a gas barrier and physically separate the electrodes. In order to fulfill these functions, the membrane should be prepared from a polymer having excellent mechanical, thermal, hydrolytic, oxidative and reductive stability. These high demands require the use of very stable polymers, which normally limits the choice of the materials.

At present, NAPHION®-type membranes available from DuPont are the most commonly known materials on the market. NAPHION®-type membranes contain perfluorinated resins having a perfluoroalkyl side chain and a perfluoroalkyl ether side chain with a sulfonic acid group at its end. Although such membranes meet many of the requirements described above, they still show some shortcomings. These shortcomings mainly include a high cost of the materials forming the membranes. In addition, the membranes show an unacceptable methanol cross-over and water transport rates and have completely inadequate properties above 100° C., an important emerging condition for which membranes will be used.

A recent development in the field of proton-conductive polymer membrane is represented by the sulfonation of atactic and syndiotactic polystyrene. Carretta et al. [J. Membr. Sci., 166, pp. 189-197, (2000)] have partially sulfonated commercially non cross-linked atactic polystyrene to various extents, obtaining a homogeneous distribution of the sulfonic acid groups in the polymer. Since the resulting materials are not cross-linked, high quality membranes were easily obtained by evaporation casting from appropriate solvents. The level of sulfonation was carefully adjusted to maximize the proton conductivity, while preventing the membrane from becoming soluble in water.

Membranes cast from these materials were investigated in relation to proton conductivity and methanol permeability in the temperature range from 20° C. to 60° C. It was found that both these properties increase as the polymer is increasingly sulfonated, with abrupt jumps occurring at a concentration of sulfonic acid groups of about 15 mol %. The most extensively sulfonated membrane exhibited conductivity equal to that of Nafion®. They have measured for a 20% degree of sulfonation a conductivity of 5·10⁻²Ω⁻¹ cm⁻¹, which is very close to the Nafion®.

European Patent No. 1179550 discloses the preparation of a polyelectrolyte membrane for fuel cells in which the polyelectrolyte comprises at least a styrenic polymer having a syndiotactic configuration (s-PS) as an essential component. The s-PS may or may not contain ion exchange groups therein. Accordingly, the polyelectrolyte is classified into two types, i.e., (1) those polyelectrolytes comprising an ion-exchange group containing thermoplastic resin other than s-PS, an ion-exchange group-free s-PS, and if required, the other ion-exchange group-free thermoplastic resin; and (2) those polyelectrolytes comprising a thermoplastic resin containing at least an ion-exchange group-containing s-PS, and if required, an ion-exchange group-free thermoplastic resin. As with the thermoplastic resins other than s-PS used in the polyelectrolytes (1) and (2), any suitable thermoplastic resins may be used without particular limitations. The weight-average molecular weight of the styrenic polymers is preferably 10,000 or higher, and more preferably 50,000 or higher. Of these styrenic polymers, syndiotactic polystyrene is especially preferred.

The ion exchange groups introduced into s-PS or the thermoplastic resins other than s-PS may be either cation exchange groups or anion exchange groups. The method of introducing the ion exchange groups into s-PS or the thermoplastic resins other than s-PS is not particularly restricted, and any known suitable methods may be used. For example, the ion exchange groups may be introduced into s-PS by heating the polymer in concentrated sulfuric acid, or by reacting the polymer with chlorosulfonic acid. After introducing the ion exchange groups, the polyelectrolyte membrane is produced by forming the above polyelectrolyte into a film. For example, the polyelectrolyte membrane is preferably produced by a solution-casting method in which the polyelectrolyte kept in a solution state is cast or spread over a substrate to form a film, or by a melt-press or melt-extrusion method in which the molten polyelectrolyte is press-molded or extrusion-molded into a film.

However, the process for obtaining the above polyelectrolyte membrane is quite complicated and requires several working steps or manufacturing due to the fact that it is necessary to perform several washing steps and filtration steps for removing the residual sulfonating reagent used for the sulfonation of the polymer. This results in a considerable waste of time and in higher production costs.

### SUMMARY OF THE INVENTION

In view of the foregoing background, an object of the present invention is to provide a polyelectrolyte membrane for electrochemical applications, and in particular, for small fuel cells having good electrical conductivity properties and which can be produced at lower costs and with a reduction of working or manufacturing steps.

This and other objects, advantages and features in accordance with the present invention are provided by a polyelectrolyte membrane comprising at least a styrenic polymer or co-polymer having a substantially syndiotactic configuration and having ion-exchange groups, characterized in that at least one styrenic polymer or copolymer is obtained in its clathrate form.

In the present invention, the term “clathrate form” relates to the trapping of compounds into cavities, preferably regularly spaced nanocavities, present in the crystalline phase of styrenic polymers or copolymers, forming so-called inclusion compounds therein. Generally, such compounds are molecules of solvents used for the preparation of styrenic polymers or copolymers, as will be explained in greater detail below.

Preferably, the styrenic polymers or copolymers used in the present invention have a substantially syndiotactic configuration, are obtained in a nanoporous crystalline form and by polymerization of styrene with olefins having the formula CH₂═CH—R in which R is an alkyl-aryl group, or a substituted aryl group having from 6 to 20 carbon atoms, or with other monomer compounds having unsaturated ethylene groups.

Representative and non-limiting examples of the styrenic polymers or copolymers are poly(p-methylstyrene), poly(m-methylstyrene), poly(p-chlorostyrene), poly(m-chlorostyrene), poly(chloromethylstyrene), poly(bromostyrene), poly(fluorostyrene), etc. The most preferred styrenic polymers used in the present invention is syndiotactic polystyrene in its clathrate form.

Preferably, the polyelectrolyte membrane according to the invention is produced by forming into a film the syndiotactic styrenic polymer or cocopolymer obtained in its clathrate form and having ion-exchange groups. The average molecular weight of the syndiotactic styrenic polymer or cocopolymer is not particularly restricted. In the case of syndiotactic polystyrene, it is preferably higher than 10,000 and more preferably between 100,000 and 1,500,000.

In the present invention, the ion exchange groups introduced into the syndiotactic styrenic polymer or co-copolymer may be either cation exchange groups or anion exchange groups. Examples of the ion exchange groups may include sulfonic group, carboxyl group, phosphoric group, quaternary ammonium salt group, primary, secondary or tertiary amine group, or the like. Of these ion exchange groups, the sulfonic group is particularly preferred.

The inventors have prepared polyelectrolyte membranes from several syndiotactic styrenic polymers and copolymers in their clathrate forms, in particular from syndiotactic polystyrene in its clathrate form, and have found after extensive studies that the membranes exhibit good electrical conductivity properties which render them suitable for electrochemical applications, in particular, for the production of fuel cells.

Syndiotactic polystyrene (s-PS) is a rigid semicrystalline material with a glass transition temperature close to 80-90° C. and a high melting temperature close to 270° C. and, unlike the corresponding isotactic polymer, it crystallizes rapidly upon cooling from the melt. Several structural studies have shown a very complex polymorphic behavior for this polymer. See for instance Y. Chatani et al., Jpn (Eng. Ed.) 37, E428 (1988); A. Immirzi et al., Makromol. Chem. Rapid Commun. 9, 761, (1988); V. Vittoria et al., Makromol. Chem. Rapid Commun. 9, 765, (1988); G. Guerra et al., Ital. Pat. 19588, (February 1989) (Himont, Inc.); V. Vittoria et al., Macromol. Sci. Phys. B28, 419 (1989); G. Guerra et al., Macromolecules 23, 1539 (1990); G. Guerra et al., Polym. Sci. Polym. Phys. Ed. 29, 265 (1990); G. Guerra et al., Polymer Commun. 32, 30 (1991); C. De Rosa et al., Polym. J. 23, 1435 (1991); M. Rapacciuolo et al., Sci. Lett. 10, 1084 (1991); C. De Rosa et al., Polymer 33, 1423 (1992); Y. Chatani et al., Polymer 33, 488 (1992); O. Greis et al., Polymer 30, 590 (1989); G. Conti et al., Mikrochim. Acta 1, 297 (1988); R. A. Niquist, Appl. Spectrosc. 43, 440 (1989); N. M. Reynolds et al., Macromolecules 22, 2867 (1989); M. Kobayashi et al., Macromolecules 23, 78 (1990); G. Guerra et al., Makromol. Chem. 191, 2111 (1990); V. Vittoria, Polymer Commun. 31, 263, (1990); A. R. Filho et al., Makromol. Chem. Rapid Commun. 11, 199 (1990); N. M. Reynolds et al., Macromolecules 23, 3463 (1990); N. M. Reynolds et al., Macromolecules 24, 3662 (1991); A. Grassi et al., Makromol. Chem. Rapid Commun. 10, 687 (1989); Gomez et al., Macromolecules 23, 3385 (1990); ibidem 24, 3533 (1991); Chatani Y. et al., Polymer, 34, 1620-1624 (1993); Chatani Y. et al., Polymer, 34, 1625-1629 (1993); De Rosa C., Macromolecules, 29, 8460-8465 (1996); De Rosa C. et al., Macromolecules, 30, 4147-4152 (1997).

Different polymorphic forms of s-PS are characterized by widely different conformations. In fact, two crystalline forms include chains with a trans-planar conformation while two crystalline forms include chains with sequences of dihedral angles corresponding to a s(2/1)2 helical symmetry. Different modes of packing in different unit cells exist for the trans-planar chains of s-PS in the so-called α and β forms, for which hexagonal and orthorhombic unit cells have been described, respectively. Instead, the chains with s(2/1)2 symmetry are present in the two crystalline forms named γ and δ. In particular, the term “δ-form” has been used to indicate different clathrate structures, which include molecules of the solvent.

As a result of extensive studies, the inventors have found that by introducing ion exchange groups into a formed film of syndiotactic polystyrene in its clathrate form, a polyelectrolyte membrane is obtained which shows good electrical conductivity as well as a low-water permeability and a long-term stability. Similar results have been also found for polyelectrolyte membranes obtained from syndiotactic styrenic polymers and co-copolymers in their clathrate forms other than syndiotactic polystyrene in its clathrate form.

The polyelectrolyte membrane according to the invention is therefore particularly suitable to be used for fuel cells and similar electrochemical applications. Without being bound to any scientific theory, it is believed that the clathrate regions into the syndiotactic styrenic polymers and copolymers, in particular into the syndiotactic polystyrene, are able to supply regular pathways into the crystalline regions for the introduction of the ion-exchange groups, in particular for the introduction of sulfonic groups via a sulfonating agent.

This induces the anchoring of regularly spaced ionic groups along the polymer backbones included in the crystalline domains, resulting advantageously in effective percolation pathways for ion transport through the membrane. In addition, the preparation of the polyelectrolyte membrane according to the invention is more straightforward and requires less working steps due to the fact that the introduction of ion-exchange groups (for example, by sulfonation) is carried out on an already formed film containing a syndiotactic styrenic polymer or co-polymer in its clathrate form. This is well explained below with reference to the preparation of the polyelecrolyte membrane according to the invention.

The present invention also relates to a method for producing a polyelectrolyte membrane comprising at least one syndiotactic styrenic polymer or co-polymer in its clathrate form and having ion-exchange groups.

According to an embodiment of the present invention, the method comprises preparing a solution containing at least one syndiotactic styrenic polymer or co-polymer in a solvent suitable to form clathrates into the at least one syndiotactic styrenic polymer or co-polymer, and treating the solution to form a film containing the at least one syndiotactic styrenic polymer or co-polymer in clathrate form. The method further comprises introducing ion-exchange groups into the film containing the at least one syndiotactic styrenic polymer or co-polymer in clathrate form, thus obtaining the polyelectrolyte membrane.

Preferably, the at least one syndiotactic styrenic polymer or co-polymer is formed by syndiotactic polystyrene. Syhdiotactic styrenic polymers or co-copolymers can be prepared (synthesized) directly into a solvent suitable to form clathrates into them or can be provided in other ways. For example, the preparation of syndiotactic polystyrene can suitably be made according to conventional procedures. Examples of suitable procedures for the preparation of syndiotactic polystyrene in its α, γ or δ polymorphic forms are described in G. Guerra et al., Macromolecules 23, 1539 (1990); Y. Chatani et al., Polymer 33, 488 (1992); Chatani Y. et al., Polymer, 34, 1620-1624 (1993); Chatani Y. et al., Polymer, 34, 1625-1629 (1993); De Rosa C., Macromolecules, 29, 8460-8465 (1996); De Rosa C. et al., Macromolecules, 30, 4147-4152 (1997).

An essential feature of the present invention is that the solvent be chosen among those able to form clathrate into the used syndiotactic styrenic polymer or copolymer such as syndiotactic polystyrene. Solvents suitable to this purpose are well-known in the art, see for instance the following: A. Del Nobile, G. Mensitieri, M. T. Rapacciuolo, P. Corradini, G. Guerra, C. Manfredi, manufactured articles of a new crystalline modification of syndiotactic polystyrene capable of forming clathrates with solvents and process for the same and Italian Patent 1271842; and Manfredi C. et al, Polym. Sci. Polym. Phys. Ed., 35, 133 (1997).

For example, suitable solvents to form clathrates in particular into syndiotactic polystyrene can be chosen from the group comprising halogenated compounds such as chloroform, methyl chloride, methylene chloride, carbon tetrachloride, dichloroethane, trichloroethylene, tetrachloroethylene, dibromoethane, methyl iodide, aromatic compounds such as benzene, o-dichlorobenzene, toluene, styrene, cyclic compounds such as cyclohexane, tetrahydrofurane and sulphur-containing compounds such as carbon sulfide. These solvents may be used alone or in the form of a mixture of any two or more thereof.

Preferably, the solvent is chosen from chloroform, methylene chloride, o-dichlorobenzene and toluene. In the preparation of the solution, the syndiotactic styrenic polymer or co-polymer is heated into the desired solvent at a temperature suitable to dissolve it. The dissolving temperature depends upon the composition of the polymer and kind of solvent used. Generally, the dissolving temperature is between −50° C. and the boiling temperature of the solvent used.

The polyelectrolyte membrane of the present invention is produced by forming the syndiotactic styrenic polymer or co-polymer into a film while the polymer or co-polymer is in its clathrate form and then by introducing ion-exchange groups into the film.

The method of forming the film of syndiotactic styrenic polymer or copolymer in a clathrate form is not particularly restricted. A solution casting method is preferably used in which the syndiotactic styrenic polymer or co-polymer kept in a solution state is in a solvent suitable to forming the clathrates is cast or spread over a substrate to form a film.

The substrate can be of any type, e.g., a glass plate, a metal plate such as a stainless steel plate or a resin sheet such as Teflon sheet and polyimide sheet. It may have a smooth surface or irregularities on its surface. After casting over the substrate with the solution prepared by dissolving the syndiotactic styrenic polymer or co-polymer used in an adequate solvent, the solvent is removed from the resultant film.

In particular, during solvent evaporation, the solution densities and the resulting polymer/solvent mixture first forms a gel, and then a solid film made of amorphous and crystalline regions. Inside the film the solvent is partly dissolved into the amorphous domains, and partly hosted into regularly spaced nanocavities present in the crystalline phase, forming so-called inclusion compounds (clathrate regions).

The presence of clathrate regions is essential for the present invention, since they supply regular pathways into the crystalline regions for the introduction of the ion-exchange groups, in particular for the introduction of sulfonic groups by means of a sulfonating agent. This induces the anchoring of regularly spaced ionic groups along the polymer backbones included in the crystalline domains, resulting advantageously in effective percolation pathways for ion transport through the membrane.

In particular, according to the invention, when sulfonic groups are introduced into the film of syndiotactic polystyrene in its clathrate form, effective percolation pathways for proton transport through the membrane can be obtained even if the degree of sulfonation is lower compared to other techniques. This confers good electrical conductivity properties to the polyelectrolyte membrane according to the invention.

In addition, it should be noted that the polyelectrolyte membrane according to the invention does not require the introduction into the polymer of a large amount of ionic groups, for example by sulfonation, in order to have the desired electrical conductivity properties. In fact, as explained above, due to the presence of clathrate regions that supply regular pathways into the crystalline regions for the introduction of the ion-exchange groups, a lower amount of ionic-groups as compared to other techniques is generally enough to ensure an acceptable electrical conductivity to the final membrane.

This is particularly advantageous since if a reduced amount of ionic groups are introduced into the polymer, the mechanical properties of the polyelectrolyte membrane are improved while at the same time, the regular disposition of ionic groups along the polymer backbones included in the crystalline domains allows good electrical conductivity properties to be obtained.

To give an example, when syndiotactic polystyrene in its clathrate form is sulfonated, the resulting polyelectrolyte membrane exhibits good electrical conductivity using a theoretic degree of sulfonation ranging from about 20% to 40% by weight on the weight of syndiotactic polystyrene.

According to another embodiment of the present invention, the method for producing a polyelectrolyte membrane comprising at least one syndiotactic styrenic polymer or co-polymer in its clathrate form having ion-exchange groups comprises providing a film of at least one syndiotactic styrenic polymer or copolymer, and contacting the film of at least one syndiotactic styrenic polymer or copolymer with a solvent suitable to form clathrates into the at least one syndiotactic styrenic polymer or co-polymer for a time sufficient to form the clathrates. A film is obtained in which the at least one syndiotactic styrenic polymer or co-polymer is in a clathrate form, The method further comprises introducing ion-exchange groups into the film of at least one syndiotactic styrenic polymer or co-polymer in its clathrate form to obtain the polyelectrolyte membrane.

Preferably, the at least one syndiotactic styrenic polymer or co-polymer is formed by syndiotactic polystyrene preferably in its α, γ or δ polymorphic form. The film can be obtained in any way, for example, by a melt-press or melt-extrusion method in which the molten syndiotactic styrenic polymer or co-polymer is press-molded or extrusion-molded to obtain a film.

The film so obtained is then contacted with a solvent suitable to form clathrate into the syndiotactic styrenic polymer or co-polymer, for example, by soaking the film into the solvent for a time sufficient to form the clathrates.

In the method according to the invention, the introduction of ion exchange groups into the syndiotactic styrenic polymer or co-polymer, in particular into the syndiotactic polystyrene, can be performed by reacting the film of syndiotactic polystyrene in its clathrate form with any suitable agent able to incorporate the desired ion groups. For example, when sulfonic groups are to be introduced into syndiotactic polystyrene, the film of syndiotactic polystyrene in its clathrate form is preferably sulfonated in concentrated sulfuric acid or chlorosulfonic acid. Preferably, for the introduction of ion-exchange groups, a solution of the appropriate agent is used in the same solvent to form clathrate in the syndiotactic styrenic polymer or co-polymer.

It will be appreciated that since in the present invention, the sulfonation is performed on the film of syndiotactic styrenic polymer or co-polymer in its clathrate form rather than in a solution containing the polymer, as taught in European Patent No. 1179550, the removal of residual sulfonating agent after sulfonation is more effective and simple. In particular, only few washings are generally necessary to remove a residual sulfonating agent from the film containing syndiotactic styrenic polymer or co-polymer in its clathrate form. This advantageously results in a reduction of the working steps and of the manufacturing costs.

As mentioned above, the ion exchange groups introduced into the film may be either cation exchange groups or anion exchange groups. Examples of the ion exchange groups include sulfonic group, carboxyl group, phosphoric group, quaternary ammonium salt group, primary, secondary or tertiary amine group, or the like. Of these ion exchange groups, the sulfonic group is preferred.

The concentration of the syndiotactic polystyrene in the solution used in the solution-casting method is not particularly restricted, and is preferably in the range of 0.03 to 10% by weight, and more preferably 0.1 to 5% by weight.

The treating temperature upon removal of the solvent varies depending upon kind of solvent used, etc., and is preferably in the range of −50 to 70° C. The removal of the solvent may be carried out under vacuum or by allowing the membrane to stand in a gas flow.

The polyelectrolyte membrane of the present invention preferably has an ion exchange capacity of 0.03 milli-equivalent/g or higher, and more preferably 0.05 to 2.0 milli-equivalent/g on the basis of the weight of a dried membrane.

The thickness of the polyelectrolyte membrane is not particularly restricted, and is preferably 0.1 to 1,000 micron, and more preferably 1 to 200 micron. When the thickness of the polyelectrolyte membrane is below the lower value indicated above, the polyelectrolyte membrane tends to fail to show a practical strength that may be used. When the thickness of the polyelectrolyte membrane is more than the maximum value indicated above, the resistance of the polyelectrolyte membrane tends to become too large, resulting in deteriorated power generation performance of fuel cells obtained therefrom. The membrane thickness may be controlled by adjusting the concentration of the syndiotactic polystyrene into the solution or the thickness of the cast-coating film formed on the substrate in the case of the solution-casting method, and by adjusting the spacer thickness, the die gap, the taking-off speed, etc., in the case of the melt-press or melt-extrusion method.

The polyelectrolyte membrane according to the invention may be reinforced with a woven fabric, etc., if required. The polyelecrolyte membrane according to the invention can be suitably used for many electrochemical applications, and in particular, for fuel cells and the like.

The fuel cell is a device for continuously generating an electric power or energy by continuously replenishing a fuel such as hydrogen and oxygen or air and simultaneously continuously discharging the reaction product composed mainly of water therefrom. As the hydrogen source, there may be used hydrogen itself as well as hydrogen derived from various hydrocarbon-based fuels such as natural gas, methane, alcohol and the like. Also, the fuel cell generally comprises electrodes, electrolyte, fuel feed device, product discharge device, etc. The electrodes contain electrode active materials.

The fuel cell of the present invention comprises the above polyelectrolyte membrane as an electrolyte. The polyelectrolyte membrane of the present invention can satisfy a good electrical conductivity, a low water permeability and also it results in considerable advantages in terms of high power density. In addition, the use of polyelectrolyte membrane according to the invention allows an avoidance of the problems normally experienced in fuel cells using a liquid electrolyte such as PEMFC cells and alkaline fuel cells.

An application particularly interesting of the polyelectrolyte membrane according to the invention is in the large-scale production of small fuel cells to be used as power generators for portable power sources. In the last few years, significant progress has been made in the development of portable electronic devices. Batteries, which have made advances in technologies represent, at present, the only option possible for devices requiring electrical powers up to 100 W. However, the main limitations of batteries for applications such as cellular phones and laptop computers are the large weight and volume, as well as the small energy density that limits the operation period before recharging. Replacement of batteries also has problems of being recycled, since the base materials cannot be easily re-used.

Such a problem can be solved using a methanol or hydrogen fuel cell comprising a polyelectrolyte membrane according to the invention instead of conventional batteries. As a matter of fact, a fuel cell according to the invention can provide an energy density 30 times higher than a conventional Ni/Cd battery. Furthermore, hydrogen rich fuels according to the invention have an electrochemical energy density two orders of magnitude higher than a battery on a weight basis.

### BRIEF DESCRIPTION OF THE DRAWINGS

The features and advantages of the polyelectrolyte membrane according to the present invention will become more evident from the following description, given by way of non-limiting examples with reference to the accompanying drawings. In the drawings:

FIG. 1 shows a differential scanning calorimeter (DSC) scan of an unfunctionalized syndiotactic polystyrene membrane for comparison purposes in accordance with the prior art;

FIG. 2 shows a thermogravimetric curve of an unfunctionalized syndiotactic polystyrene membrane for comparison purposes in accordance with the prior art;

FIG. 3 shows a DSC scan of a melt-quenched sulfonated s-PS membrane according to the present invention;

FIG. 4 shows a thermogravimetric curve of a melt-quenched sulfonated s-PS membrane according to the present invention;

FIG. 5 shows an infrared spectra of an unfunctionalized s-PS membrane according to the present invention; and

FIG. 6 shows an infrared spectrum of an sulfonated s-PS membrane according to the present invention.

### DETAILED DESCRIPTION OF THE PREFERRED EMBODIMENTS

Preparation of polyelectrolyte membranes contain syndiotactic polystyrene in its clathrate form. Four samples (A to D) of syndiotactic polystyrene having the weight indicated in TABLE 1 were individually mixed with 20 ml of chloroform (99,9% HPLC grade, Aldrich Chemicals) and heated to about 100° C. for 1.5 hours until the polymer was completely dissolved. In accordance with the solution-casting method, the solutions were individually cooled at room temperature and then poured into a Petri dish until a partial evaporation of the solvent occurred. A film of s-PS having polymorphic clathrate form was thus obtained from each solution.

Each film was then sulfonated to introduce ionic groups into the s-PS having polymorphic clathrate form using chlorosulfonic acid. A procedure modified from the method for the chlorosulfonation of styrene divinylbenzene co-polymers used by Rabia et al., React. Function. Polym. 28, 279 (1996) was modified.

In accordance with this procedure, each of the above-mentioned films produced by a solution-casting method was soaked in 40 ml of an associated solution of chloroform and chlorosulfonic acid (99%, Aldrich Chemicals) at room temperature for 4 hours. The volume content of chlorosulfonic acid is indicated in TABLE 1 for each solution used. During the soaking time, each film underwent sulfonation and the degree of sulfonation was controlled by the chlorosulfonic acid concentration according to conventional techniques.

TABLE 1

| Sample | s-PS (g) | Chlorosulfonic acid (ml) | Sulfonation (%) |
|---|---|---|---|
| A | 0.5148 | 0.103 | 15.565 |
| B | 0.4904 | 0.15 | 23.796 |
| C | 0.4908 | 0.18 | 28.532 |
| D | 0.4867 | 0.2 | 31.969 |

The reaction mechanism for chlorosulfonic acid is described from the following equation:
2 HOSO₂C1⇄H₂+O—SO₂C1+SO₃+Cl⁻⇄⁺SO₂C1+HC1+HSO₄₋Ar+⁺SO₂Cl+HSO₄₋+HCl→ArSO₂C1+H₂SO₄+HC1.
Overall reaction: Ar+2 HOSO₂C1, ArSO₂C1+H₂SO₄+HCl.

After the desired time reaction, each sulfonated membrane that was obtained was washed with deionized water to facilitate the complete removal of residual sulfonating reagent from the functionalized s-PS film. The sulfonated membrane was then stirred in a 1 M NaOH (Sodium hydroxide 97% 20-40 Mesh bead, Aldrich Chemicals) solution at room temperature to hydrolyze the sulfonyl chloride to sulfonic group according to the following equation:
ArSO₂C1+NaOH→ArSO₃H+NaCl.
Finally, each membrane was washed with water and dried in oven under vacuum at 60° C. for 1 hour.

The membranes were characterized as to their thermal properties and behavior of sulfonated syndiotactic polystyrene which were compared to corresponding thermal properties and to behavior of an unfunctionalized (i.e., without sulfonic groups) syndiotactic polystyrene membrane. For the sake of simplicity, only the results of the investigations on the membrane obtained from the sample C are shown. Similar results were obtained by the investigations on the membranes prepared from the samples A, B and D.

A TA Instrument 2910 Differential Scanning Calorimeter (DSC) equipped with a nitrogen purge was used to study the thermal properties of the syndiotactic polystyrene and sulfonated syndiotactic polystyrene. A TA Instrument 2950 Termogravimetric balance (TGA) equipped with a nitrogen purge was used to study the thermal behavior of s-PS and sulfonated s-PS. Infrared spectra were obtained with a Nicolet Nexus FT-IR. Membranes were characterized by FT-IR spectroscopy to ascertain the presence of sulfonated groups attached to the phenyl rings.

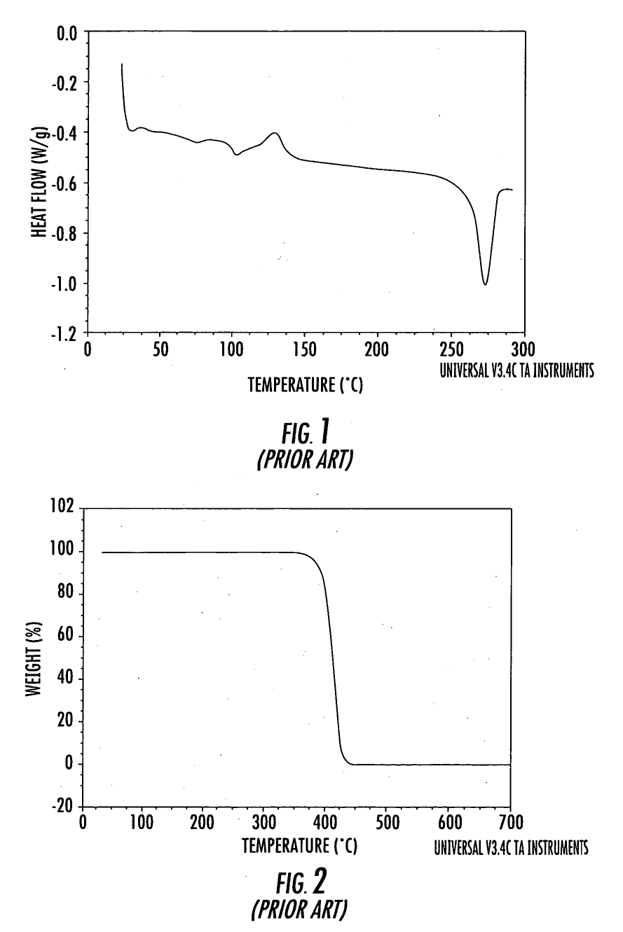

FIG. 1 illustrates the DSC scan for an unfunctionalized syndiotactic polystyrene membrane. For thermal scan the heating rate is 10° C./min. The glass transition temperature (T_{g}) of s-PS is about 100° C., the crystallization temperature (T_{c}) is about 130° C., and the melting temperature (Tₘ) is about 270° C.

FIG. 2 illustrates the TG curve for an unfunctionalized syndiotactic polystyrene membrane. For a thermal scan the heating rate is 10° C./min. Up to 370° C., the s-PS membrane is stable but near 400° C. it begins to degrade.

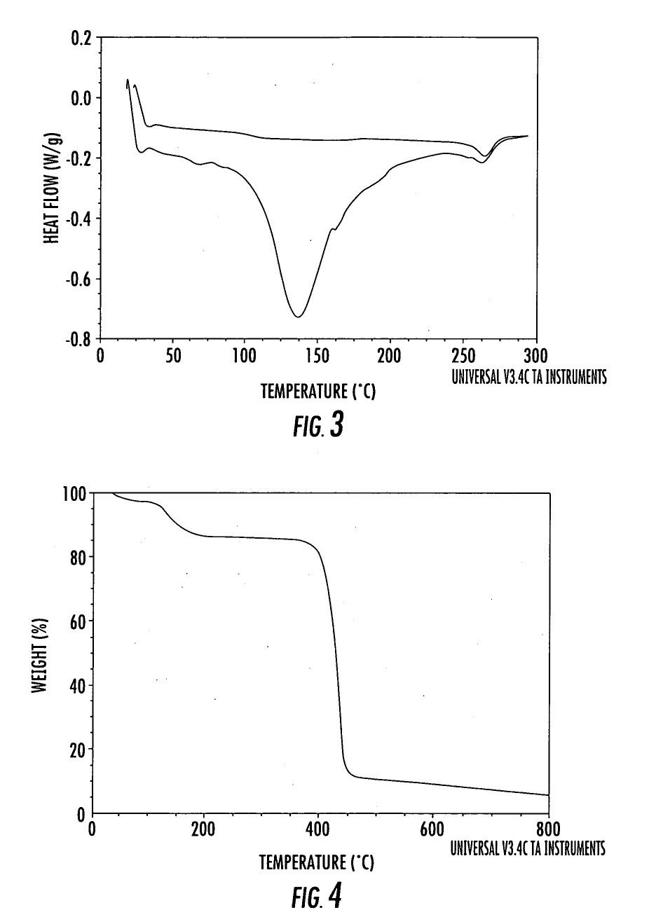

To characterize the sulfonated s-PS membrane, the samples were heated to 300° C. and then rapidly cooled (quenched) to the starting temperature of 25° C. and then scanned to 300° C. The thermal behavior of meltquenched sulfonated s-PS membrane (sample C) is displayed in FIG. 3. For thermal scan the heating rate is 10° C./min. During the first scan the sample shows a broad peak of about 100° C. to indicate the presence of water in the sample, which means the presence of ion-exchange groups. The second scan shows the glass transition temperature (T_{g}) at about 100° C., and the melting temperature (Tm) at about 270° C. The DSC scan in FIG. 3 compared to the DSC scan in FIG. 1, shows the sulfonation of syndiotactic polystyrene membrane.

FIG. 4 illustrates the TG scan for a sulfonated s-PS membrane (sample C). For thermal scan the heating rate is 10° C./min. Up to 370° C., sulfonated s-PS membrane is a stable material. The only water loss occurs at about 90° C. and acid loss at about 130° C., but between 400° C. and 800° C. a weight loss clearly occurs, which means that a degradation has occurred.

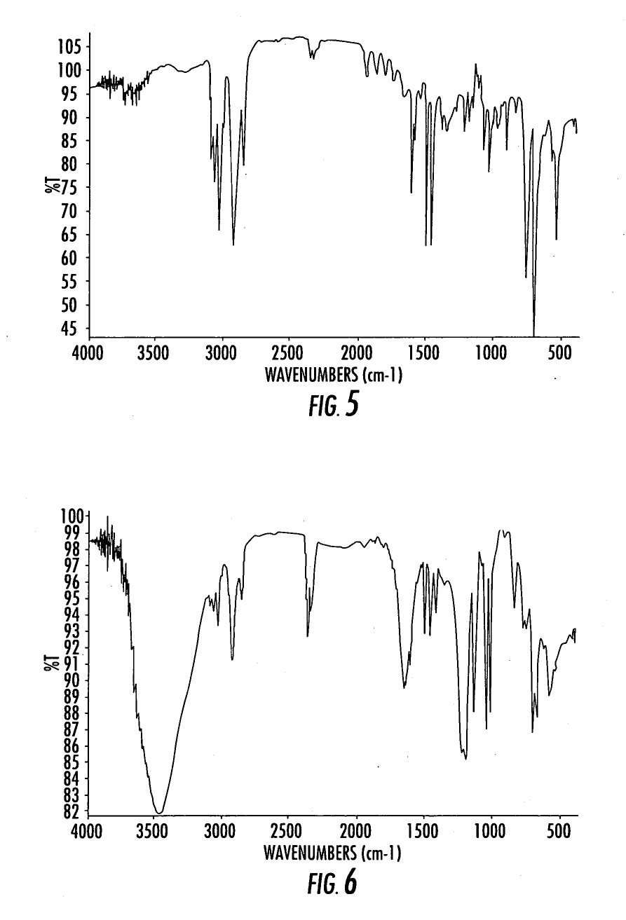

FIG. 5 illustrates the FT-IR spectra of s-PS membrane, and FIG. 6 illustrates the FT-IR spectra of sulfonated s-PS membrane. The most prominent band to confirm sulfonation of the polystyrene is observed in range 1000÷1300 cm⁻¹. Further evidence of s-PS sulfonation is gained by observing the peak at 3500 cm⁻¹.

To measure the water content, the membrane (sample C) was immersed in distilled water for 24 hours or longer at room temperature. Then, after water attached on the surface of the membrane, it was wiped off and the weight W₁ (g) of the membrane was measured. Further, the membrane was dried at 120° C. for 4 hours, and the weight W₂ (g) thereof was measured. The water content C(%) of the membrane was calculated from the following expression:
C(%)=[(W₁−W₂)/W₁]×100.
For sample C the measurement of water content is 62.27%.

To measure the ion exchange capacity, the membrane (sample C) was immersed in distilled water for 24 hours at room temperature. Then, after water attached on surface of the membrane, it was wiped off and the wet weight W (g) of membrane was measured. The membrane was placed in 150 ml of a 3.0 mol/liter potassium chloride aqueous solution and titrated with 0.01 mol/liter potassium hydroxide aqueous solution, for 24 hours at room temperature. From the measured volume V (liter) of the potassium hydroxide aqueous solution required for the neutralization titration, the ion exchange capacity (E) of the membrane was calculated according to the following expression:
E(milli-equivalent/g)=0.01×V/[W×(1−C/100)]
For sample C, the measurement of the ion exchange capacity is 0.05 milliequivalent/g.

The above measured ion exchange capacity of the membrane indicates that not all —SO₃H groups available from the sulfonating agent are effective in bonding to the syndiotactic polystyrene through the sulfonation. This is however, advantageous since according to the invention the ionic groups (—SO₃H groups) are introduced and regularly spaced into the crystalline regions only along the pathways interested by the ion transport. This results in good electrical conductivity of the membrane.

To measure the electrical conductivity of the membrane, the membrane (sample C) was immersed in distilled water for 2 hours at room temperature and then, after water attached on surface of the membrane, it was wiped off and the electrical conductivity of membrane was measured. Membrane conductivity was determined from a lateral resistance of the membrane that was measured using a four-point-probe electrochemical impedance spectroscopy technique.

A BekkTech Conductivity Cell was used to provide a simple fixture for loading a membrane and performing four-point-probe conductivity tests. The cell had two platinum foil outer current-carrying electrodes and two platinum wire inner potential-sensing electrodes. The inner electrodes had a diameter of 0.75 mm and were placed at a distance of 0.425 cm. A membrane sample was cut into a strip that was approximately 1.0 cm wide, 2 cm long and 0.02 cm thick prior to mounting in the conductivity cell.

The conductivity cell, with the membrane sample loaded, is fitted between the anode and cathode conduction plates of Fuel Cell Technologies Hardware. Impedance measurement was made using a Solartron SI 1280B electrochemical impedance analyzer to measure the sample resistance. The instrument was used in galvanostatic mode with AC current amplitude of 0.01 mA over a frequency range from 0.1 to 20,000 Hz. A base value of membrane conductivity of about 14.0 mS/cm was obtained from a sample resistance measurement at an environmental temperature. The above measured electrical conductivity is satisfactory for several electrochemical applications.

1-25. (Cancelled).

26. A polyelectrolyte membrane comprising:
at least one styrenic polymer or co-polymer having a substantially syndiotactic configuration and comprising ion-exchange groups, said at least one styrenic polymer or co-polymer being obtained in its clathrate form.

27. A polyelectrolyte membrane according to claim 26, wherein said at least one styrenic polymer or co-polymer in its clathrate form is formed into a film, and said ion-exchange groups are introduced into the film.

28. A polyelectrolyte membrane according to claim 27, wherein said at least one styrenic polymer or co-polymer in its clathrate form comprises syndiotactic polystyrene.

29. A polyelectrolyte membrane according to claim 26, wherein said ion-exchange groups comprise sulfonic groups.

30. A method for producing a polyelectrolyte membrane comprising at least one syndiotactic styrenic polymer or co-polymer in its clathrate form and comprising ion-exchange groups, the method comprising:
preparing a solution containing at least one syndiotactic styrenic polymer or co-polymer in a solvent for forming clathrates in the at least one syndiotactic styrenic polymer or co-polymer;
treating the solution for forming a film containing the at least one syndiotactic styrenic polymer or co-polymer in its clathrate form; and
introducing ion-exchange groups into the film containing the at least one syndiotactic styrenic polymer or co-polymer in its clathrate form for obtaining the polyelectrolyte membrane.

31. A method according to claim 30, wherein the at least one syndiotactic styrenic polymer or co-polymer comprises syndiotactic polystyrene.

32. A method according to claim 31, wherein the solvent comprises at least one of chloroform, methylene chloride, odichlorobenzene and toluene.

33. A method according to claim 30, wherein treating the solution to form the film comprises spreading the solution and the solvent over a substrate and removing the solvent thereform.

34. A method according to claims 30, wherein the ion exchange groups comprise sulfonic groups.

35. A method according to claim 34, wherein the sulfonic groups are introduced by reacting the film with a sulfonating agent.

36. A method according to claim 35, wherein the sulfonating agent comprises at least one of concentrated sulfuric acid and chlorosulfonic acid.

37. A method according to claim 35, wherein the at least one syndiotactic styrenic polymer or co-polymer comprises syndiotactic polystyrene; and wherein the sulfonating agent is in a solution state, the solvent of this solution being the same solvent used to form clathrate in the at least one syndiotactic styrenic polymeric or copolymer or into the syndiotactic polystyrene.

38. A method for producing a polyelectrolyte membrane comprising at least one syndiotactic styrenic polymer or co-polymer in its clathrate form and comprising ion-exchange groups, the method comprising:
providing a film of at least one syndiotactic styrenic polymer or copolymer;
contacting the film with a solvent for forming a film in which the at least one syndiotactic styrenic polymer or co-polymer is in its clathrate form; and
introducing the ion-exchange groups into the film in which the at least one syndiotactic styrenic polymer or co-polymer is in its clathrate form for obtaining the polyelectrolyte membrane.

39. A method according to claim 38, wherein the at least one syndiotactic styrenic polymer or co-polymer comprises syndiotactic polystyrene.

40. A method according to claim 39, wherein the syndiotactic polystyrene is in its α, γ or δ polymorphic form; and wherein the film is obtained by a melt-press or a melt-extrusion.

41. A method according to claim 38, wherein contacting the film with a solvent comprises soaking the film in the solvent for a time sufficient to form the clathrates.

42. A method according to claim 38, wherein the ion-exchange groups comprise sulfonic groups.

43. A method according to claim 42, wherein the sulfonic groups are introduced by reacting the film with a sulfonating agent.

44. A method according to claim 43, wherein the sulfonating agent comprises at least one of concentrated sulfuric acid and chlorosulfonic acid.

45. A method according to claim 43, wherein the sulfonating agent is in a solution state, and the solvent of this solution is the same solvent used to form the clathrates.

46. A fuel cell comprising:
a polyelectrolyte membrane comprising
at least one styrenic polymer or co-polymer having a substantially syndiotactic configuration and comprising ion-exchange groups, said at least one styrenic polymer or co-polymer being obtained in its clathrate form.

47. A fuel cell according to claim 46, wherein said at least one styrenic polymer or co-polymer in its clathrate form is formed into a film and said ion-exchange groups are introduced into the film.

48. A fuel cell according to claim 47, wherein said at least one styrenic polymer or co-polymer in its clathrate form comprises syndiotactic polystyrene.

49. A fuel cell according to claim 46, wherein said ion-exchange groups comprise sulfonic groups.

50. A fuel cell according to claim 46, wherein said a polyelectrolyte membrane is configured so that the fuel cell is a power generator for a portable power source.
